(19) United States
(12) Patent Application Publication
(10) Pub. No.: US 2014/0270717 A1
(43) Pub. Date: Sep. 18, 2014

(54) SYSTEM AND METHOD FOR CONTROLLING AND MANAGING DIGITAL MEDIA RECORDING

(71) Applicant: GENERAL INSTRUMENT CORPORATION, Horsham, PA (US)

(72) Inventors: Kuang M. Chen, San Diego, CA (US); William P. Franks, San Diego, CA (US); Paul Moroney, La Jolla, CA (US)

(73) Assignee: GENERAL INSTRUMENT CORPORATION, Horsham, PA (US)

(21) Appl. No.: 14/207,479

(22) Filed: Mar. 12, 2014

Related U.S. Application Data
(60) Provisional application No. 61/801,127, filed on Mar. 15, 2013.

(51) Int. Cl. H04N 21/4227; H04N 21/4147; H04N 21/433; H04N 21/41

(52) U.S. Cl. CPC H04N 21/4227; H04N 21/4126; H04N 21/4147; H04N 21/4334
USPC 386/299

(57) ABSTRACT

A method of scheduling a digital video recording via a remote device, comprising providing a digital video recorder comprising one or more tuners and a recording database stored on a storage device within the digital video recorder, the recording database being configured to store one or more recording schedules that describe programming events to be recorded by the digital video recorder, receiving a message over a data network connection from a remote device, the message describing instructions to add a new recording schedule about a particular programming event to the recording database, comprising a program identifier, a program name, a program icon URL, a channel identifier, a start time, an end time, a deletion priority, and a recording type, processing the message to add the new recording schedule to the recording database, and transmitting an error message to the remote device when the new recording schedule conflicts with another recording schedule already stored in the recording database.

### CLAIM OF PRIORITY

This application claims priority under 35 U.S.C. §119(e) from earlier filed U.S. Provisional Application Ser. No. 61/801,127, filed Mar. 15, 2013, which is hereby incorporated by reference.

### TECHNICAL FIELD

The present disclosure relates to the field of digital video recorders, particularly a system for managing recording schedules based on instructions from remote devices.

### BACKGROUND

Consumers have come to enjoy using digital video recorders (DVRs) to record live television broadcasts for later playback. A DVR generally allows a user to use a remote control to search for programs, schedule recordings, play recordings, delete recordings, or otherwise control the DVR and its recording schedule.

DVRs can be incorporated into Home Media Gateways or other devices that can be connected to one or more televisions. By way of a non-limiting example, a Home Media Gateway can be a single cable box connected to multiple televisions throughout a home, such that television signals received by the Home Media Gateway can be streamed to any of the connected televisions within the home, and/or recordings stored on the Home Media Gateway can be viewed on any television within the home.

Traditionally, scheduling recordings on a DVR or Home Media Gateway was possible only by using a remote control to add, change, and/or delete scheduled recordings. A remote control must generally be in physical proximity to the DVR or Home Media Gateway, which precludes remote scheduling of recordings over data networks using connected devices such as mobile phones. The remote control model also does not allow for the receipt of instructions from multiple users or remote devices, some of which may be sending conflicting instructions at or near the same time.

### SUMMARY

What is needed is a method of remotely accepting instructions from users to manage a recording schedule on a DVR or Home Media Gateway. This method should allow a user to send scheduling instructions and other messages to the DVR or Home Media Gateway remotely through a computer, mobile phone, tablet computer, or other device over a network or data connection, instead of requiring use of a physical remote control in the presence of the DVR or Home Media Gateway. For instance, a user may realize after he has left his house that he has forgotten to set a recording for a program that is set to air while he will be away from home. In this situation, the user can use an application on his mobile phone to schedule the desired recording on his DVR remotely.

It can also be desirable to allow multiple users to remotely manage the recording schedule of a single DVR or Home Media Gateway. For instance, multiple family members can each desire to record different programs, and each can use their own device to remotely schedule recordings on the same DVR or Home Media Gateway. The DVR or Home Media Gateway can inform users of scheduling conflicts or other errors that arise when accepting instructions. For instance, two family members may concurrently attempt to remotely schedule different conflicting recordings, and the DVR or Home Media Gateway can inform the users of the scheduling conflict.

In one embodiment, the present disclosure provides for a method of scheduling a digital video recording via a remote device, comprising providing a digital video recorder comprising one or more tuners and a recording database stored on a storage device within the digital video recorder, the recording database being configured to store one or more recording schedules that describe programming events to be recorded by the digital video recorder, receiving a message over a data network connection from a remote device, the message describing instructions to add a new recording schedule about a particular programming event to the recording database, comprising a program identifier, a program name, a program icon URL, a channel identifier, a start time, an end time, a deletion priority, and a recording type, processing the message to add the new recording schedule to the recording database, and transmitting an error message to the remote device when the new recording schedule conflicts with another recording schedule already stored in the recording database.

In another embodiment, the present disclosure provides for a TCP/IP message containing data elements for recording a programming event, comprising a program identifier, a program name, a program icon URL, a channel identifier, a start time, an end time, a deletion priority, and a recording type.

In yet another embodiment, the present disclosure provides for a method of supplying status information about tuners within a digital video recorder to a remote device, comprising providing a digital video recorder comprising one or more tuners, receiving a request for tuner status information over a data network connection from a remote device, transmitting the tuner status information to the remote device, the tuner status information comprising, for each of the one or more tuners, a tuner number, a channel identifier, a stream type, a manifest URL, a tuner status, and a pending channel identifier.

### BRIEF DESCRIPTION OF THE DRAWINGS

Further details of the present invention are explained with the help of the attached drawings in which:

FIG. 1 depicts an exemplary embodiment of a Home Media Gateway (HMG) and connected IP Client Devices (ICDs).

FIG. 2 depicts an exemplary embodiment of a recording schedule.

FIG. 3 depicts an exemplary embodiment of a recording file.

FIG. 4A depicts an exemplary Add Recording Schedule Uniform Resource Locator (Add-URI).

FIG. 4B depicts the exemplary Add-URI of FIG. 4A with each of its components on a separate line.

FIG. 5A depicts an exemplary Retrieve Recording Schedule Uniform Resource Locator (Retrieve-URI).

FIG. 5B depicts an exemplary XML file containing two recording schedules.

FIG. 6A depicts an exemplary Change Recording Schedule Uniform Resource Locator (Change-URI).

FIG. 6B depicts the exemplary Change-URI of FIG. 6A with each of its components on a separate line.

FIG. 7A depicts an exemplary Retrieve Tuner Status Uniform Resource Locator (TunerStatus-URI).

FIG. 7B depicts an exemplary XML file containing status information about tuners in an HMG.

### DETAILED DESCRIPTION

FIG. 1 depicts an exemplary embodiment of a Home Media Gateway (HMG) 100. An HMG 100 can be a device configured to tune into, receive, and record television signals, such as cable, satellite, or other types of television signals. In some embodiments, an HMG 100 can be a cable box or other set-top box that comprises a digital video recorder (DVR). In other embodiments, an HMG 100 can be a stand-alone DVR. In still other embodiments, an HMG 100 can be part of a computer, gaming console, or other device that can tune into, receive, and record television signals. In some embodiments and/or situations, a single HMG 100 can be connected to multiple televisions, such that the HMG 100 can be accessible from any of the connected televisions to watch live or recorded television. By way of a non-limiting example, some HMGs 100 can be connected to multiple televisions in a single home, and any of the televisions within the home can access live television broadcasts and/or recordings from the centralized HMG 100. In other embodiments and/or situations, an HMG 100 can be dedicated to a single television.

An HMG 100 can comprise or have access to at least one tuner 102, one or more storage devices 104, and one or more transcoders 106. The tuners 102 can be configured to tune into and receive television signals. The storage devices 104 can be memory, such as a hard drive or flash memory. The transcoders 106 can be configured to record and/or convert television signals received by the tuners 102 and digitally store the received content on the storage device 104.

In some embodiment, an HMG 100 can comprise a plurality of tuners 102, such that the HMG 100 can tune into, display, and/or record multiple television signals simultaneously. By way of a non-limiting example, some HMGs 100 have four tuners, such that two of its tuners 102 can provide live television broadcasts to two different televisions, while the other two tuners 102 can record two other television broadcasts onto the HMG's storage device 104.

An HMG 100 can store, update, and maintain a recording database 108. In some embodiments, the recording database 108 can be stored on the same storage device 104 that stores recorded television content. In other embodiments, the recording database 108 can be stored in separate memory or storage in the HMG 100. The recording database 108 can be in communication with the tuners 102, storage devices 104 and/or transcoders 106. The recording database 108 can be a database, list, or file describing recordings that have been scheduled to take place in the future and/or recordings already stored on the storage device 104. In some embodiments, information about scheduled recordings and/or recordings already stored on the HMG 100 can be saved as XML (Extensible Markup Language) files in the recording database 108. In some embodiments, information about each scheduled recording can be stored on the HMG 100 in a recording schedule 200, and information about each completed recording can be stored in a recording file 300.

An HMG 100 can be connected to a data network, such as a wired or wireless internet and/or data connection, such that it can exchange data with one or more IP Client Devices (ICDs) 110 over the network. An ICD 110 can be a mobile phone, smart phone, computer, tablet computer, personal media player, gaming console, or any other device that can connect to a network, and/or an application or program running on such a device.

An ICD 110 can be configured to communicate with an HMG 100 over a network regardless of the ICD's proximity to the HMG 100. In some embodiments, an ICD 110 can communicate with an HMG 100 by exchanging messages using TCP/IP (Transmission Control Protocol/Internet Protocol). By way of a non-limiting example, an ICD 110 can exchange data with the HMG 100, such as interacting with the HMG 100 to add, change, or retrieve information in the HMG's recording database 108 as will be discussed below.

FIG. 2 depicts an exemplary embodiment of a recording schedule 200 that can be stored in the recording database 108. A recording schedule 200 can describe information and/or attributes of a programming event set to be recorded by the HMG 100 in the future. The recording database 108 can store one or more recording schedules 200, one for each scheduled recording. In some embodiments, a particular recording schedule 200 can describe a scheduled recording that is set to recur, such as a weekly recording of each episode of a weekly television series. In other embodiments, a particular recording schedule 200 can describe a scheduled recording that is set to occur once, such as a recording of a single episode of a television program or a single airing of a movie.

A recording schedule 200 can have multiple fields that describe a particular programming event set to be recorded by the HMG 100, and/or fields that indicate how the HMG 100 should treat a recording as it is being recorded or after it is stored onto the storage device 104. The recording schedule can comprise fields for a Program ID 202, a Program Name 204, a Program Icon URL 206, a Channel ID 208, a Start Time 210, an End Time 212, a Delete Priority 214, a Recording Type 216, a Transcoding Priority 218, and/or other any other attribute describing a scheduled recording event.

The Program ID 202 can be a unique identifier for the particular programming event described by the recording schedule 200. In some embodiments, the Program ID 202 can be consistent with an asset identifier or other identifier used to refer to the programming event in an electronic programming guide (EPG), such as an on-screen program guide, schedule, or other listings that the HMG 100 can display to a user.

The Program Name 204 can be the name of the particular programming event described by the recording schedule 200, such as the title of a television series or a movie.

The Program Icon URL 206 can be a URL that points to an icon or graphic associated with the particular programming event described by the recording schedule 200. By way of a non-limiting example, a television program can have an associated icon that displays a title card, logo, screenshot, cast photograph, or other image associated with the television program, and the Program Icon URL 206 can indicate a network location from which that icon can be retrieved.

The Channel ID 208 can be an identifier of the television channel on which the particular programming event described by the recording schedule 200 will be broadcast. The Channel ID 208 can indicate a channel to which a tuner 102 within the HMG 100 should be tuned to when the particular programming event is set to occur.

The Start Time 210 can be the time at which the broadcast of the particular programming event described by the recording schedule 200 is scheduled to begin. In some embodiments, the Start Time 210 can be indicated in Coordinated Universal Time (UTC). In alternate embodiments, the Start Time 210 can be indicated in a local time zone or in any other time standard.

The End Time 212 can be the time at which the broadcast of the particular programming event described by the recording schedule 200 is scheduled to end. In some embodiments, the End Time 212 can be indicated in Coordinated Universal Time (UTC). In alternate embodiments, the End Time 212 can be indicated in a local time zone or in any other time standard.

The Delete Priority 214 can indicate whether or not a recording that results from the scheduled recording of the particular programming event described by the recording schedule 200 and is stored on the HMG 100 is authorized to be deleted, and/or when deletion of that recording is authorized. As will be discussed below, the Delete Priority 214 contained in the recording schedule 200 can be transferred to the Delete Priority 314 field in a recording file 300 as a recording is occurring or after the recording has finished, in order to indicate how the resulting recording should be later treated by the HMG 100. In some embodiments, the Delete Priority 214 and/or Delete Priority 314 can be set to “default delete” (“dd”), “delete never” (“dn”), “delete recording” (“dr”), or other similar flags or values.

Setting the Delete Priority 214 and/or Delete Priority 314 to “dd,” “default delete,” or other similar flag or value can indicate that the resulting recording can be deleted automatically when space is needed on the storage device 104. By way of a non-limiting example, “dd” can authorize the HMG 100 to delete a particular recording on the storage device 104 if there is not enough empty space on the storage device 104 to record a new programming event.

Setting the Delete Priority 214 and/or Delete Priority 314 to “dn,” “delete never,” or other similar flag or value can indicate that the resulting recording is not authorized for automatic deletion, and should only be deleted upon further user instruction.

Setting the Delete Priority 214 to “dr,” “delete recording,” or other similar flag or value can indicate that the recording schedule 200 itself should be deleted from the recording database 108, such that the programming event described by the recording schedule 200 is no longer set to be recorded by the HMG 100. As will be discussed below with reference to Delete Priority 314, “dr” or other similar flag can also be received as an instruction to delete a previous recording already saved on the HMG 100. In some embodiments, when the HMG 100 receives a “dr” or similar instruction in regards to a particular recording schedule 200 or programming event, it can delete the recording schedule 200 so that no further recordings are made. However, the HMG 100 can maintain any previous recordings stored on the HMG 100 that were recorded pursuant to the now-deleted recording schedule 200 until those stored recordings are also deleted through a separate “dr” or similar instruction. By way of a non-limiting example, a recording schedule 200 can describe a recurring recording schedule for a television series, and when a “dr” instruction is received the HMG 100 can cancel future scheduled recordings but maintain previously recorded episodes unless deletion of the previously recorded episodes is also requested.

The Recording Type 216 can indicate a video type or format that the HMG 100 should use when recording the particular programming event described by the recording schedule 200. By way of a non-limiting example, a transcoder 106 can transcode a television signal received by a tuner 102 into a recording according to the video type or format denoted by the Recording Type 216. The Recording Type 216 can describe an encoding profile, video compression format, audio compression format, video resolution, and/or any other attribute that the HMG 100 should use when generating a recording according to the recording schedule 200. In some embodiments, the Recording Type 216 can be an integer or other identifier that refers to preselected video types. By way of non-limiting examples, in some embodiments: a Recording Type 216 of “1” can refer to video encoded at half-VGA resolution using the H.264 main profile with audio encoded using AAC-LC; a Recording Type 216 of “2” can refer to video encoded at 720×480p resolution using the H.264 main profile at 30 frames per second; and a Recording Type 216 of “3” can refer to video encoded at 1280×720p resolution using the H.264 main profile at 30 frames per second. In other embodiments, any other preselected or non-preselected format or video type can be denoted by the Recording Type 216.

The Transcoding Priority 218 can indicate whether a transcoder 106 within the HMG 100 should prioritize transcoding the recording scheduled for this particular programming event over other recordings or live programming. In some embodiments, the time it takes to transcode a programming event into a recording can delay subsequent viewing of the recording, and it can be desired that the transcoding of a particular programming event be prioritized over transcoding of other programming events or live television. In these situations and/or embodiments, the Transcoding Priority 218 can be set to “tp,” “top priority,” or other similar flag or value such that transcoding of this scheduled recording should be prioritized over any conflicting scheduled recording not set to the highest priority. In other embodiments, the Transcoding Priority 218 can be an integer, such that the integers in the respective Transcoding Priority 218 fields of conflicting scheduled recordings can be compared to determine which scheduled recording has a higher priority and should be given priority during transcoding.

In alternate embodiments, the Transcoding Priority 218 field can be absent, but a scheduled recording's priority can be determined by its order within a master recording schedule. By way of a non-limiting example, the recording database 108 can store a master recording schedule in a XML file that contains a plurality of recording schedules 200, with the relative priority of each indicated by its order within the XML file. For instance, a recording schedule 200 that appears higher in the master recording schedule XML file can take priority over a recording schedule 200 that appears lower in the XML file. In these embodiments, “tp” can be received as an instruction to re-order the master recording schedule to put a particular recording schedule 200 at the highest priority position.

FIG. 3 depicts an exemplary embodiment of a recording file 300 that can be stored in the recording database 108. A recording file 300 can describe information and/or attributes of a recording of a programming event that has been fully or partially recorded and stored onto the HMG 100. The recording database 108 can store one or more recording files 300, one for each recording saved on a storage device 104.

A recording file 300 can have multiple fields that describe a particular recording saved on the HMG 100. The recording schedule can comprise fields for a Program ID 302, a Program Name 304, a Program Icon URL 306, a Channel ID 308, a Start Time 310, an End Time 312, a Delete Priority 314, a Recording Type 316, and/or other any other attribute describing a stored recording.

In some embodiments, the fields of the recording file 300 can be populated with corresponding fields from a recording schedule 200 that the HMG 100 followed when initially recording and saving the particular recording described by the recording file 300, such that information known about the programming event in the recording schedule 200 is also known in the recording file 300 associated with a recording. By way of a non-limiting example, the HMG 100 can follow a recording schedule 200 to record a particular programming event, and at least some of the fields in the recording schedule 200 can be propagated to a recording file 300 that describes the resulting recording that is saved to the storage device 104. In some embodiments, Program ID 302, Program Name 304, Program Icon URL 306, Channel ID 308, Start Time 310, End Time 312, and Recording Type 316 in the recording file 300 can respectively correspond to and be propagated from Program ID 202, Program Name 204, Program Icon URL 206, Channel ID 208, Start Time 210, End Time 212, and Recording Type 216 in the recording schedule 200. By way of a non-limiting example, a recording generated by an HMG 100 according to a particular recording schedule 200 can be associated with a new recording file 300 that includes information about the programming event that was recorded, such as a unique identifier, name, icon URL, channel identifier, start and end times, and the recording's video type or format.

A recording file 300 can further have a Delete Priority 314 field. As with Delete Priority 214, Delete Priority 314 in a recording file 300 can be set to “dd,” “default delete,” or other similar flag or value to indicate that the corresponding recording can be deleted automatically if additional space is needed on the storage device 104, “dn,” “delete never,” or other similar flag or value to indicate that the corresponding recording should not be deleted automatically, or “dr,” “delete record,” or other similar flag or value to actually delete the corresponding recording.

Delete Priority 314 in a recording file 300 can in some embodiments be initially propagated from Delete Priority 214 in a corresponding recording schedule 200. By way of a non-limiting example, Delete Priority 214 can have been set to “dn” in the recording schedule 200 to indicate that a user desired that any recordings that resulted from the recording schedule 200 should not be deleted unless the user later instructed, and therefore that preference can be propagated to the Delete Priority 314 field of the recording file 300 after the recording is generated and stored by the HMG 100. In other embodiments, Delete Priority 314 can initially be set to “dd” or other similar flag or value by default.

Delete Priority 314 can be changed by the HMG 100, such as in response to a message received from an ICD 110 or a remote control, to change the deletion status of a particular recording saved on the storage device 104. By way of a non-limiting example, Delete Priority 314 can be changed from “dd” to “dn” so that the recording is no longer set to be automatically deleted when space is low on the storage device 104. Similarly, Delete Priority 314 can be changed to “dr” or other similar flag or value at any time to delete the recording from the storage device 104. As discussed above, in some situations and/or embodiments receipt of a first “dr” instruction can delete a recording schedule but not delete any actual recordings, while additional “dr” instructions can result in deletion of actual recordings from the storage device 104.

As shown in FIG. 1, one or more ICDs 110 can be in data communication with an HMG 100. An ICD 110 can exchange information with an HMG 100 through TCP/IP based messaging or other messaging protocols to add new recording schedules 200 to the HMG's recording database 108, edit existing recording schedules 200 on the recording database 108, retrieve recording schedules 200 stored on the recording database 108, change the deletion priority of an existing recording schedule 200 or recording file 300 stored on the recording database 108 and/or storage device 104, retrieve status information about tuners 102 within the HMG 100. In some embodiments, messages can be exchanged between ICDs 110 and an HMG 100 using Uniform Resource Identifiers (URIs) that point to network locations of directories and/or data on the HMG 100 such as recording schedules 200, recording files 300, information about tuners 102, and/or any other type of data.

FIG. 4A depicts an Add Recording Schedule Uniform Resource Identifier (Add-URI) 400, and FIG. 4B depicts an Add-URI 400 with each of its components on a separate line. An Add-URI 400 can be a URL that includes instructions to add a new recording schedule 200 to the recording database 108 of an HMG 100 in order to schedule a new recording of a programming event in the future. In some embodiments, an Add-URI 400 can be similar to a POST request method in HTML (Hypertext Transfer Protocol).

The Add-URI 400 can comprise a network location 402 of the HMG's recording database 108, such as an IP address or domain name. The Add-URI 400 can also comprise a payload that includes one or more of a plurality of metadata elements that indicate information about a particular programming event to be recorded by the HMG 100. The metadata elements can be one or more of the fields that can be saved within the recording database 108 as a new recording schedule 200, such a Program ID 202, Program Name 204, Program Icon URL 206, Channel ID, 208, Start Time 210, End Time 212, Delete Priority 214, and/or Recording Type 216, as shown in FIGS. 4A and 4B. As discussed above, the Delete Priority 214 in an Add-URI 400 and/or Recording schedule 200 can indicate what Delete Priority 314 should be associated with a recording that results from the recording schedule 200 after the programming event is recorded by the HMG 100.

An ICD 110 can submit instructions through an Add-URI 400 to an HMG 100 to schedule a new recording and add a new recording schedule 200 to the HMG's recording database 108 according to the metadata elements of the Add-URI 400. If the HMG 100 is not able to add the requested recording to its recording database 108, the HMG 100 can return an error to the ICD 110. One type of error indicate that the HMG 100 does not have a tuner 102 available for the requested recording described by the Add-URI 400, such as if other recordings have already been scheduled all tuners 102 are scheduled to be in use at the time of the requested recording. Other errors can indicate that the start time of the requested recording is in the past, that the requested recording has already been scheduled, that the HMG 100 does not have access to the requested channel, or any other error. The error can be displayed on the ICD 110 that sent the Add-URI 400, such that a user of the ICD 110 can attempt to reschedule the recording at a different time, delete other scheduled recordings to create tuner 102 availability, or correct the error in any other desired manner.

In some embodiments, when more than one recording schedule 200 is added for the same programming event, but the Recording Type 216 is different in each, multiple recordings can be generated for the same programming event, such that recordings having different Recording Types 316 are generated. In alternate embodiments, an error can be returned when a second recording schedule 200 is added for a programming event that has already been scheduled with a different Recording Type 216.

In some embodiments, if multiple recording schedules 200 for the same programming event on the same Channel ID 208 are received, but have different start times 210 and/or end times 212, the HMG 100 can merge the overlapping recording schedules 200, such that a single recording with the earlier start time 210 and the later end time 212 is scheduled. In alternate embodiments, an error can be returned in this situation.

FIG. 5A depicts a Retrieve Recording Schedule Uniform Resource Identifier (Retrieve-URI) 500. A Retrieve-URI 500 can be a URL that an ICD 110 can use to request a list of all recording schedules 200 stored on the recording database 108 for current and/or upcoming recordings. In some embodiments, the recording schedules 200 returned in a response to a Retrieve-URI 500 can omit information about recordings made in the past, but information about those recordings can be returned in response to a separate request for recording files 300, for instance through a Content Directory API.

In some embodiments, a Retrieve-URI 500 can be similar to a GET request method in HTML. The Retrieve-URI 500 can comprise a network location of the HMG's recording database 108, such as an IP address, domain name, and/or directory in which recording schedules 200 are stored.

An ICD 110 can submit a Retrieve-URI 500 to an HMG 100 to retrieve a list of the current and/or upcoming recording schedules 200 from the HMG 100. In some embodiments, the list of recording schedules 200 can be returned to the requesting ICD 110 as an XML file. By way of a non-limiting example, FIG. 5B depicts an exemplary XML file containing recording schedule 200a and recording schedule 200b for two upcoming programming events that have been set to be recorded.

In some embodiments, the HMG 100 can return an error message to the requesting ICD 110 after receiving a Retrieve-URI 500, such as if no recordings are set for the future and no recording schedules 200 are found on the recording database 108, or any other error with the retrieval of recording schedules 200 from the recording database 108. The error can be displayed on the ICD 110 that sent the Retrieve-URI 500, such that a user of the ICD 110 can attempt to retry the request to retrieve recording schedules 200, or correct the error in any other desired manner.

FIG. 6A depicts a Change Recording Schedule Uniform Resource Identifier (Change-URI) 600, and FIG. 6B depicts a Change-URI 600 with each of its components on a separate line. A Change-URI 600 can be a URL that includes instructions to edit or delete either a recording schedule 200 or a completed recording already stored on the HMG 100. In some embodiments, a Change-URI 600 can be similar to a POST request method in HTML.

The Change-URI 600 can comprise a network location 602 of the HMG's recording database 108, such as an IP address or domain name. The Change-URI 600 can also comprise a payload that includes one or more of a plurality of metadata elements that indicate information about a particular programming event for which a recording schedule 200 or recording file 300 should be changed or deleted. The metadata elements can be one or more of a Program ID 202 or 302, Transcoding Priority 218, and/or Delete Priority 214 or 314, as shown in FIGS. 6A and 6B. A Change-URI 600 can thus be used by an ICD 110 to do one or more of the following: change the priority of a previously scheduled recording; delete or change the deletion priority of a previously scheduled recording; and/or delete or change the deletion priority of an already recorded recording.

As discussed above, the Transcoding Priority 218 can be changed to “tp,” “top priority,” or other similar flag or value to indicate that transcoding of a new or scheduled recording should be prioritized over other conflicting scheduled recordings. In some embodiments, when a Change-URI 600 includes a Program ID 202 and a Transcoding Priority 218 of “tp” or other similar flag or value, an already-existing recording schedule 200 in the recording database 108 that corresponds to the specified Program ID 202 can have its Transcoding Priority 218 changed to indicate that the scheduled recording has top transcoding priority. In alternate embodiments, an already-existing recording schedule 200 corresponding to the Program ID 202 in a received Change-URI 600 can be moved to the highest position in a prioritized list of recording schedules 200 when a Transcoding Priority 218 in the Change-URI 600 indicates that the recording has top priority.

In some embodiments, the Delete Priority 214 within a Change-URI 600 can indicate that the Delete Priority 214 in a particular recording schedule 200 should be changed, or that the recording schedule 200 should be deleted. By way of non-limiting examples, the Change-URI 600 can have a Delete Priority 214 to change the Delete Priority of a particular recording schedule 200 to: “dn,” “delete never,” or other similar flag or value to indicate that a recording that results from the recording should not be deleted absent additional instruction; or a Delete Priority 214 of “dd,” “default delete,” or other similar flag or value to indicate that the resulting recording can be deleted when the storage device 104 is near capacity. If the Change-URI 600 refers to an already-recorded program, the Delete Priority 214 in the Change-URI 600 can instruct the HMG 100 to change the Delete Priority 314 in a Recording File 300 to “dn” or “dd,” or other similar flags or values.

The Delete Priority 214 can additionally be set to “dr,” “delete recording,” or other similar flag or value in the Change-URI 600. In some embodiments, when the HMG 100 receives a Change-URI 600 with a “dr” Delete Priority 214, it can first delete a recording schedule 200 associated the Program ID 202 in the Change-URI 600, in order to cancel a future scheduled recording, or recurring scheduled recording. If the HMG 100 receives a second Change-URI 600 with the same Program ID 202 that has a Delete Priority 214 of “dr,” the HMG 100 can also delete any or all previously recorded recordings associated with that Program ID 202.

An ICD 110 can submit instructions through a Change-URI 600 to an HMG 100 to edit or delete either a specified recording schedule 200 already stored in the HMG's recording database 108 or a specified already-completed recording stored on the HMG's storage device 104. The HMG 100 can return a message to the ICD 110 either indicating that the requested change or deletion was performed successfully, or, if the HMG 100 was not able to change or delete the specified recording schedule 200 or saved recording, an error message. An error message can indicate that the specified recording schedule 200 or completed recording was not found, that the Recording Priority 220 for the specified recording schedule 200 cannot be raised or is already at the highest priority, that the Delete Priority 214 could not be changed to “delete never,” that the Delete Priority 214 could not be changed to “default delete,” that a recording schedule 200 or saved recording could not be deleted, or any other type of error. The error can be displayed on the ICD 110 that sent the Change-URI 600, such that a user of the ICD 110 can attempt to retry the change or deletion, or correct the error in any other desired manner.

FIG. 7A depicts a Retrieve Tuner Status Uniform Resource Identifier (TunerStatus-URI) 700. A TunerStatus-URI 700 can be a URL that an ICD 110 can use to request a list of the status of all tuners 102 within an HMG 100. In some embodiments, a TunerStatus-URI 700 can be similar to a GET request method in HTML. The TunerStatus-URI 700 can comprise a network location for the HMG 100, such as an IP address, domain name, and/or directory in which information about the tuners 102 are stored.

An ICD 110 can submit a TunerStatus-URI 700 to an HMG 100 to retrieve status information 702 about each of the HMG's tuners 102. In some embodiments, the status information 702 about the tuners 102 can be returned to the requesting ICD 110 as an XML file. By way of a non-limiting example, FIG. 7B depicts an exemplary XML file containing status information 702 about tuners 102 in an HMG 100.

The status information 702 regarding the tuners 102 returned to the requesting ICD 110 can include information about each tuner 102 in the HMG 100. For each particular tuner 102, the status information 702 can include a Tuner Number 704 for the particular tuner 102, a Channel ID 706 that the tuner 102 is currently set to, a Stream Type 708, a Manifest File URL 710, a Tuner Status 712 for the particular tuner 102, a Pending Channel ID 714, and/or an Error Code 716.

In some embodiments, the status information 702 can include information about all tuners 102 in the HMG 100. If a tuning error with respect to a particular tuner 102 has occurred, or is occurring at the time the status information 702 is sent to the requesting ICD 110, the tuner's Tuner Number 704, the Channel ID 706 of the channel that the tuner 102 is or was attempted to be tuned to, and an Error Code 716 regarding the tuning error can be listed in the status information 702 for that tuner 102. By way of a non-limiting example, the status information 702 of FIG. 7B shows tuner number 3 with a Channel ID 706 and an Error Code 716. If any tuner 102 is not tuned to a channel at the time the status information 702 is sent to the requesting ICD 110, the status information 702 can list the tuner number alone without any other information. By way of a non-limiting example, the status information 702 of FIG. 7B shows tuner number 4 by itself, indicating that it is not tuned to a channel.

The Tuner Number 704 can be a number or other identifier assigned to a particular tuner 102 within an HMG 100. By way of a non-limiting the exemplary HMG 100 shown in FIG. 1 comprises four tuners 102, and each tuner 102 can be assigned a unique number identifier, such as “1,” “2,” “3,” and “4.”

The Channel ID 706 can be a channel that the tuner 102 is tuned into and/or receiving a broadcast signal from at the time the status information is sent to the requesting ICD 110. The Channel ID 706 can refer to the same channel identifiers as the Channel ID 208 in a recording schedule 200 or Channel ID 308 in a recording file 300. In some embodiments, when the Channel ID 706 in the status information 702 indicates “0,” it can indicate that the tuner 102 is presently receiving an Emergency Alert System signal.

The Stream Type 708 can indicate the type of recording or video stream being produced by the tuner 102 and/or transcoder 106 connected to the tuner 102. The Stream Type 708 can indicate a video type or encoding format that the tuner 102 and/or transcoder 106 is using to process a received television signal for live television viewing and/or generating recordings. In some embodiments, the Stream Type 708 can correspond to a Recording Type 216. By way of a non-limiting example, a tuner 102 can have tuned to a specific channel to record a programming event pursuant to a recording schedule 200, and the tuner 102 and/or transcoder can record the programming event according to the Recording Type 216 indicated by the recording schedule 200, such as Recording Types 216 “1,” “2,” or “3” discussed above. In this example, the Stream Type 708 can report the Recording Type 216 of the video being processed by the tuner 102 and/or transcoder 106.

The Manifest File URL 710 can be a uniform resource locator file for a playlist associated with the media stream associated with the broadcast signal received by the tuner 102. In some embodiments, the requesting ICD 110 can use the Manifest File URL 710 to request and receive the media stream associated with that tuner 102 from the HMG 100 over a data network. By way of a non-limiting example, in addition to submitting or editing recording schedules 200, in some embodiments an ICD 110 can view recorded or streamed media content from the HMG 100 by accessing the media stream at the playlist indicated by the Manifest File URL 710.

The Tuner Status 712 can indicate one of more of the following: “recording,” “recording pending,” “streaming shared,” and/or “streaming exclusive.” In some embodiments, “recording” can be indicated by “R,” “recording pending” can be indicated by “P,” “streaming shared” can be indicated by “SS,” and “streaming exclusive” can be indicated by “SX.”

A Tuner Status 712 of “recording” can indicate that, at the time the status information is sent to the requesting ICD 110, the tuner 102 is currently being used to record a program.

A Tuner Status 712 of “recording pending” can indicate that at, the time the status information is sent to the requesting ICD 110, the tuner 102 is set to record a programming event on a different channel within a preset duration of time in the future. By way of a non-limiting example, in some embodiments “P” can indicate that the tuner 102 is scheduled to begin recording a programming event on a different channel within the next minute. When the Tuner Status 712 is set to “recording pending,” the status information 702 can also include a Pending Channel ID 714 for the channel to which the tuner 102 is scheduled to change to begin the next recording. Reporting “recording pending” information to an ICD 110 can inform a user that the tuner 102 is about to be change the current channel to the Pending Channel ID 714 to begin the next recording, such that the user has the option of cancelling the scheduled recording with a Change-URI 600 to remain on the currently streaming channel.

A Tuner Status 712 of “streaming shared” can indicate that, at the time the status information is sent to the requesting ICD 110, the tuner 102 is currently being used for live streaming and that more than one ICD 110 is accessing a live content stream associated with the tuner 102. As discussed above, in some embodiments an ICD 110 can request and receive a media content stream from the HMG 100 for viewing on the ICD 110, and the Tuner Status 712 can indicate how many ICDs 110 are receiving a content stream associated with a particular tuner 102.

A Tuner Status 712 of “streaming exclusive” can indicate that, at the time the status information is sent to the requesting ICD 110, the tuner 102 is currently being used for live streaming, and that a single ICD 110 is accessing a content stream associated with the tuner 102.

The Tuner Statuses 712 of “streaming shared” and “streaming exclusive” can be mutually exclusive, in that streaming exclusive” is used when a single ICD 110 is currently accessing the tuner's stream, and “streaming shared” is used when more than one ICD 110 is currently accessing the tuner's stream. As the number of ICDs 110 accessing a tuner's stream changes, the Tuner Status 712 can alternate between “streaming shared” and “streaming exclusive” based on the numbers of ICDs 110 accessing the tuner's stream. As discussed above, if no ICDs 110 are accessing the stream and the tuner 102 is not tuned to a channel, then the status information 702 for that tuner 102 can include just the Tuner Number 704 without other information.

The Tuner Status 712 can denote multiple status types for the same tuner 102 denoted together in a string, In some embodiments, each status can separated by a separator symbol, such as “|.” By way of a non-limiting example, a Tuner Status 712 of “SSA” can indicate that the tuner's current status is both “streaming-shared” and “currently recording.” By way of another non-limiting example, a Tuner Status 712 of “SX|R|P” can indicate that the tuner's current status is “streaming exclusive,” “recording,” and also “recording pending.”

An Error Code 716 can indicate a tuner error for a particular tuner 102. An Error Code 716 can indicate that a tuner 102 was tuned to an invalid channel, a blocked channel, a channel that a user or subscriber has not been authorized to view, or any other type of tuner error. The tuner error indicated by the Error Code 716 can be displayed on the ICD 110 that sent the TunerStatus-URI 700, such that a user of the ICD 110 can change the tuner 102 to a different channel, or correct the error in any other desired manner.

In use, an ICD 110 can submit an Add-URI 400, a Retrieve-URI 500, a Change-URI 600, and/or a TunerStatus-URI 700 to manage scheduled recordings and completed recordings on an HMG 100. Through information returned to the ICD 110 in response to the requests sent through these URIs, the ICD 110, or a user of the ICD 110, can dynamically and intelligently manage or resolve any scheduling or tuner conflicts that arise.

By way of a non-limiting example, an ICD 110 that requests that a new recording be scheduled via an Add-URI 400 can be informed that the requested recording cannot be scheduled because all of the HMG's tuners 102 have been scheduled for other recordings at the time of the requested recording, thereby allowing the ICD 110 or its user to delete other scheduled recordings, change the requested recording to another instance of the programming event that will be broadcast at a different time, cancel the requested recording, or resolve the conflict in any other way.

By way of another non-limiting example, an ICD 110 can know up front through the results of a Retrieve-URI 500 and/or TunerStatus-URI 700 that all tuners 102 are busy or will be busy during a certain timeframe, and present options to a user to resolve the conflict or otherwise dynamically resolve the conflict according to preselected preferences. For instance, a user of the ICD 110 can have indicated that in the event of a scheduling conflict, the recording that was scheduled first should be deleted to make room for a scheduled recording added more recently.

As another non-limiting example, information retrieved by an ICD 110 through a Retrieve-URI 500 and/or TunerStatus-URI 700 can inform a viewer currently watching a particular programming event on particular channel via a stream from a tuner 102 that the tuner 102 is scheduled to be tuned to a different channel in the future pursuant to a recording schedule 200. For instance, a Tuner Status 712 of “recording pending” can indicate that the tuner 102 is set to be changed to a different channel within the next minute for an upcoming scheduled recording. This information can be used by an ICD 110, or a user of the ICD 110, to delete or reschedule the upcoming recording, such that the current streaming programming is not interrupted by a change to a different channel.

Although the invention has been described in conjunction with specific embodiments thereof, it is evident that many alternatives, modifications and variations will be apparent to those skilled in the art. Accordingly, the invention as described and hereinafter claimed is intended to embrace all such alternatives, modifications and variations that fall within the spirit and broad scope of the appended claims.

What is claimed:

1. A method of scheduling a digital video recording via a remote device, comprising:
providing a digital video recorder comprising one or more tuners and a recording database stored on a storage device within said digital video recorder, said recording database being configured to store one or more recording schedules that describe programming events to be recorded by said digital video recorder;
receiving a message over a data network connection from a remote device, said message describing instructions to add a new recording schedule about a particular programming event to said recording database, comprising a program identifier, a program name, a program icon URL, a channel identifier, a start time, an end time, a deletion priority, and a recording type;
processing said message to add said new recording schedule to said recording database; and
transmitting an error message to said remote device when said new recording schedule conflicts with another recording schedule already stored in said recording database.

2. The method of claim 1, wherein said message is a TCP/IP message.

3. The method of claim 1, wherein said deletion priority is selected from the group consisting of default delete, delete never, and delete recording.

4. The method of claim 3, wherein when said deletion priority is default delete, a recording generated and stored on said digital video recorder pursuant to said new recording schedule is set to be maintained on said digital video recorder until said storage device is out of space.

5. The method of claim 3, wherein when said deletion priority is delete never, a recording generated and stored on said digital video recorder pursuant to said new recording schedule is set to be maintained on said digital video recorder until said an instruction is received to delete said recording.

6. The method of claim 3, further comprising deleting an existing recording schedule from said recording database when said deletion priority is delete recording.

7. The method of claim 6, further comprising deleting an existing recording stored on said storage device when a second message is received that comprises a deletion priority of delete recording.

8. The method of claim 1, wherein said recording type describes a video encoding format to be used when said digital video recorder records said particular programming event pursuant to said new recording schedule.

9. A TCP/IP message containing data elements for recording a programming event, comprising:
a program identifier,
a program name,
a program icon URL,
a channel identifier,
a start time,
an end time,
a deletion priority, and
a recording type.

10. A method of supplying status information about tuners within a digital video recorder to a remote device, comprising:
providing a digital video recorder comprising one or more tuners;
receiving a request for tuner status information over a data network connection from a remote device;
transmitting said tuner status information to said remote device, said tuner status information comprising, for each of said one or more tuners, a tuner number, a channel identifier, a stream type, a manifest URL, a tuner status, and a pending channel identifier.

11. The method of claim 10, wherein said tuner status comprises a status of streaming-shared to indicate that a particular tuner described by said tuner status information is currently streaming video to a plurality of remote devices.

12. The method of claim 10, wherein said tuner status comprises a status of streaming-exclusive to indicate that a particular tuner described by said tuner status information is currently streaming video to a single remote device.

13. The method of claim 10, wherein said tuner status comprises a status of recording to indicate that a particular tuner described by said tuner status information is currently recording a video signal received at said digital video recorder.

14. The method of claim 10, wherein said tuner status comprises a status of recording pending to indicate that a particular tuner described by said tuner status information is scheduled to be tuned to a different channel than the current channel and is scheduled to begin recording a programming event on said different channel within a preset duration of time.
